(19) United States
(12) Patent Application Publication
(10) Pub. No.: US 2026/0308372 A1
(43) Pub. Date: Oct. 8, 2026

(54) BIODEGRADABLE RESIN COMPOSITION

(71) Applicant: MITSUBISHI GAS CHEMICAL COMPANY, INC., Tokyo (JP)

(72) Inventors: Noriyuki NISHI, Tokyo (JP); Takehiko ISOBE, Tokyo (JP); Kohei YOSHIYA, Tokyo (JP); Hinata YOKOKAWA, Tokyo (JP)

(73) Assignee: MITSUBISHI GAS CHEMICAL COMPANY, INC., Tokyo (JP)

(21) Appl. No.: 19/481,912

(22) PCT Filed: May 10, 2024
(86) PCT No.: PCT/JP2024/017339

§ 371 Date: Nov. 6, 2025

(30) Foreign Application Priority Data
May 17, 2023 (JP) 2023-081389

(51) Int. Cl. C08L 67/00; C08G 63/16; C08G 64/02; C08L 69/00

(52) U.S. Cl. CPC C08L 67/00; C08G 63/16; C08G 64/02; C08L 69/005; C08L 2201/06

(57) ABSTRACT

Provided are: a biodegradable resin composition having excellent melt fluidity while maintaining favorable mechanical strength; and a molded body using the biodegradable resin composition. This biodegradable resin composition comprises: a polyester (PE) that contains a structural unit (A) derived from a monomer represented by general formula (1) and a structural unit (B) derived from a monomer represented by general formula (2); and a polyester carbonate (PEC) that contains a structural unit (A) derived from a monomer represented by general formula (1) and a structural unit (B) derived from a monomer represented by general formula (2). Formula (1): HO—(CH₂)n-OH (In general formula (1), n represents an integer of 4-16.) Formula (2): R₁OOC—(CH₂)m-COOR₂

### TECHNICAL FIELD

The present invention relates to a biodegradable resin composition. More particularly, the present invention relates to a biodegradable resin composition comprising a polyester and a polyester carbonate.

### BACKGROUND ART

Conventionally, plastic materials, such as polyethylene, polypropylene, polyethylene terephthalate, and nylon, have been used and consumed in large quantities as molding materials. While some of these plastic materials are recycled, they are generally subjected to treatment such as incineration or burial in landfills after being collected. However, they may be left uncollected because of the large amount of labor and expense required to collect them or because they are difficult to collect. In response to these environmental issues, there has been a demand for the development of polymeric materials that can degrade in the natural environment. Among them, biodegradable plastics, which are decomposed by microorganisms, are expected to be environmentally compatible materials and new types of functional materials.

Polyester carbonate resins (hereinafter also referred to as “PEC”) are known as plastics with biodegradability (e.g., Patent literature 1-2). As environmental issues have received more attention in recent years, the importance of having biodegradability as a resin characteristic has become clearer. Under these circumstances, various developments for biodegradable resin compositions are carried out.

### CITATION LIST

### Patent Literature

Patent literature 1: Japanese Unexamined Patent Application Publication No. H8-193125
Patent literature 2: Japanese Unexamined Patent Application Publication No. H8-134196

### SUMMARY OF INVENTION

### Technical Problem

Although polyester carbonates have excellent mechanical strength, there was room for improvement, for example, in melt flowability for molding precision molded bodies. Therefore, the present invention provides a biodegradable resin composition having excellent melt flowability while maintaining good mechanical strength, and a molded body using the biodegradable resin composition.

### Solution to Problem

the present inventors, after diligent study, found that the above problem can be solved by adding a polyester (hereinafter also referred to as “PE”) containing a structural unit (A) represented by general formula (1) and a structural unit (B) represented by general formula (2) to a polyester carbonate containing a structural unit (A) represented by general formula (1) and a structural unit (B) represented by general formula (2).

Thus, the present invention provides the following aspects.

<1> A biodegradable resin composition comprising:
a polyester (PE) containing a structural unit (A) derived from a monomer represented by general formula (1) below and a structural unit (B) derived from a monomer represented by general formula (2) below; and
a polyester carbonate (PEC) containing a structural unit (A) derived from a monomer represented by general formula (1) below and a structural unit (B) derived from a monomer represented by general formula (2) below:

HO—(CH₂)n-OH (1)
(in general formula (1), n represents an integer of 4-16)

R₁OOC—(CH₂)m-COOR₂ (2)
(in general formula (2), R₁ and R₂ are each independently selected from a hydrogen atom and a C1-C5 alkyl group, and m represents an integer of 2-16).
   <2> The resin composition according to <1>, wherein the mass ratio (PE:PEC) of the polyester (PE) to the polyester carbonate (PEC) is 0.1:99.9-50:50.
   <3> The resin composition according to <1> or <2>, wherein the hydroxyl value (OH value) of the polyester (PE) is 30-140 mgKOH/g.
   <4> The resin composition according to any one of <1>-<3>, wherein the weight average molecular weight (Mw) of the polyester (PE) is 3,000-8,000.
   <5> The resin composition according to any one of <1>-<4>, wherein the weight average molecular weight (Mw) of the polyester carbonate (PEC) is 100,000-300,000.
   <6> The resin composition according to any one of <1>-<5>, wherein
the monomer represented by general formula (1) above comprises 1,4-butanediol, and
the monomer represented by general formula (2) above comprises succinic acid or adipic acid.
   <7> The resin composition according to any one of <1>-<6>, wherein at least either one of the monomer represented by general formula (1) above and the monomer represented by general formula (2) above is derived from a biomass resource.
   <8> A molded body comprising the biodegradable resin composition according to any one of <1>-<7>.

### Advantageous Effects of Invention

The present invention can provide a biodegradable resin composition with good mechanical strength and excellent melt flowability. The present invention can also provide a molded body using the biodegradable resin composition.

### DESCRIPTION OF EMBODIMENTS

Hereinafter, the present invention will be described in more detail. The description of each component is representative of one embodiment of the present invention, and the present invention is not limited thereto.

Herein, a numerical value range expressed using “-” refers to a range that includes the numerical values before and after the “-” as the lower and upper limit values, respectively. Herein, a lower or upper limit value refers to a range including said lower or upper limit value.

### [Biodegradable Resin Composition]

A biodegradable resin composition of the present invention comprises: a polyester (PE) containing a structural unit (A) derived from a monomer represented by general formula (1) below and a structural unit (B) derived from a monomer represented by general formula (2) below; and a polyester carbonate (PEC) containing a structural unit (A) derived from a monomer represented by general formula (1) below and a structural unit (B) derived from a monomer represented by general formula (2) below:

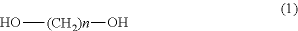

(in general formula (1), n represents an integer of 4-16)

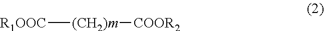

(in general formula (2), R₁ and R₂ are each independently selected from a hydrogen atom and a C1-C5 alkyl group, and m represents an integer of 2-16).

A polyester (PE) and a polyester carbonate (PEC) contained in a biodegradable resin composition of one aspect of the present invention may have both of the structural units (A) and (B) identical, either of the structural units (A) or (B) identical, or both of the structural units (A) and (B) different.

A biodegradable resin composition of a preferred aspect of the present invention comprises a polyester (PE) and a polyester carbonate (PEC) having identical structural units (A) and structural units (B).

Also, in one aspect of the present invention, a biodegradable resin composition may contain only one or a combination of two or more types of monomers represented by general formula (1) or general formula (2) above, respectively.

In general formula (1) above, n may be an integer of 4-16, 4-14, 4-12, 4-10, 4-8, 4-6, or 4.

Specific examples of the monomer represented by general formula (1) above include aliphatic dihydroxy compounds such as 1,4-butanediol, 1,3-butanediol, 1,2-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, and 1,16-hexadecanediol.

In general formula (2) above, R₁ and R₂ are each independently selected from a hydrogen atom and a C1-C5 alkyl group. The number of carbons of alkyl groups that may be selected as R₁ and R₂ may be 1-4, 1-3, 1 or 2, 2-5, 2-4, 2 or 3, 3-5, 3 or 4, or 4 or 5.

Alkyl groups that may be selected as R₁ and R(2 may be linear or branched chain alkyl groups, and specific examples include propyl groups such as a methyl group, an ethyl group, an n-propyl group, and an isopropyl group, and butyl groups such as an n-butyl group, an isobutyl group, an s-butyl group, and a t-butyl group.

In general formula (2) above, m may be an integer of 2-16, 2-14, 2-12, 2-10, 2-8, 2-6, 2-4, or 2.

Also, specific examples of the monomer represented by general formula (2) above include aliphatic dibasic acids such as succinic acid, glutaric acid, adipic acid, azelaic acid, suberic acid, sebacic acid, and dodecanoic acid (lauric acid). These aliphatic dibasic acids may be esters or acid anhydrides thereof.

In the biodegradable resin composition of one aspect of the present invention, n in general formula (1) above represents an integer of 4-6, and R₁ and R₂ in general formula (2) above are each independently selected from a hydrogen atom and a C1-C3 alkyl group, and m in general formula (2) above is an integer of 2-4.

In the biodegradable resin composition of one aspect of the present invention, the monomer represented by general formula (1) above comprises 1,4-butanediol and the monomer represented by general formula (2) above comprises succinic acid or adipic acid.

Also, in the biodegradable resin composition of one aspect of the present invention, the monomer represented by general formula (1) above and the monomer represented by general formula (2) above may be made using a raw material derived from a fossil resource such as petroleum or coal, or using a raw material derived from a biomass resource such as a plant. In a biodegradable resin composition of a preferred aspect of the present invention, at least either one of the monomer represented by general formula (1) and the monomer represented by general formula (2) is derived from a biomass resource. In a biodegradable resin composition of a more preferred aspect of the present invention, both of the monomer represented by general formula (1) and the monomer represented by general formula (2) are derived from a biomass resource.

Biomass resources include those converted from the solar energy through photosynthesis of plants and stored in the form of starch, cellulose, etc., the bodies of animals that grow to adults by eating plant matter, and products made by processing plant or animal matter. Specific examples include wood, rice straw, rice bran, old rice, corn, sugarcane, cassava, sago palm, soy pulp, corncobs, tapioca residue, bagasse, vegetable oil residue, potatoes, buckwheat, soybeans, oil and fat, used paper, papermaking residue, marine product residue, livestock waste, sewage sludge, and food waste. Among them, plant resources such as wood, rice straw, old rice, corn, sugarcane, cassava, sago palm, soy pulp, corncobs, tapioca residue, bagasse, vegetable oil residue, potatoes, buckwheat, soybeans, oil and fat, used paper, and papermaking residue are preferred, More preferable examples include wood, rice straw, old rice, corn, sugarcane, cassava, sago palm, potatoes, oil and fat, used paper, and papermaking residue, and the most preferable examples include corn, Sugarcane, cassava, and sago palm.

In one aspect of the present invention, the mass ratio (PE:PEC) of the polyester (PE) to the polyester carbonate (PEC) is preferably 0.1:99.9-50:50, and also preferably 0.1:99.9-40:60, 1.0:99.0-30:70, 1.0:99.0-20:80, 1.0:99.0-10:90, or 1.0:99.0-5.0:95.0.

By keeping the PE:PEC within the above range, a biodegradable resin composition with excellent melt flowability can be prepared while maintaining good mechanical strength.

In one aspect of the present invention, the weight average molecular weight (Mw) of the polyester (PE) is preferably 3,000-8,000, more preferably 3,500-7,000, and still more preferably 4,000-6,000.

By keeping the Mw within the above range, a biodegradable resin composition with excellent melt flowability can be prepared while maintaining good mechanical strength.

In one aspect of the present invention, the weight average molecular weight (Mw) of the polyester carbonate (PEC) is preferably 100,000-300,000, more preferably 130,000-280,000, and still more preferably 150,000-260,000.

The weight average molecular weight (Mw) of the polyester carbonate (PEC) in one aspect of the present invention may have a lower limit value of 190,000 or more, 200,000 or more, or more than 210,000. In this case, the upper limit value of Mw may be any of the above ranges.

By keeping the Mw within the above range, a biodegradable resin composition with excellent melt flowability can be prepared while maintaining good mechanical strength.

Herein, a weight average molecular weight (Mw) refers to a polystyrene-equivalent weight average molecular weight, which can be measured by the method described in EXAMPLES below.

In one aspect of the present invention, the hydroxyl value (OH value) of the polyester (PE) is preferably 30-140 mgKOH/g, more preferably 55-85 mgKOH/g, and still more preferably 60-80 mgKOH/g.

By keeping the hydroxyl value (OH value) within a range of 30 mgKOH/g or higher, the affinity with the polyester carbonate (PEC) is improved, which allows the resulting biodegradable resin composition to maintain good physical properties. In addition, by keeping the hydroxyl value (OH value) within a range of 140 mgKOH/g or lower, the hydrolyzability of the resulting biodegradable resin composition can be prevented from becoming too high.

Herein, a hydroxyl value (01H value) refers to a value measured in accordance with JIS K-1557.

### [Method for Producing Biodegradable Resin Composition]

The method for producing a biodegradable resin composition of the present invention is not particularly limited, but for example, a biodegradable resin composition of one aspect of the present invention can be produced by a stepwise method that includes primary and secondary reactions described below. For a stepwise method for obtaining a biodegradable resin composition, reference can be made, for example, to the methods described in Japanese Unexamined Patent Application Publication Nos. H8-134196 and H8-301999.

### (Primary Reaction)

A compound containing a structural unit (A) derived from a monomer represented by general formula (1) above and a compound containing a structural unit (B) derived from a monomer represented by general formula (2) above are subjected to a polycondensation reaction in the presence of a catalyst to obtain a polyester (PE) as a prepolymer.

### (Secondary Reaction)

The polyester (PE) obtained in the primary reaction and a carbonate diester are subjected to polycondensation reaction in the presence of a catalyst to obtain a polyester carbonate (PEC).

The catalyst used in the primary and secondary reactions may be a basic compound catalyst, a transesterification catalyst, or a mixed catalyst consisting of both.

Examples of the basic compound catalyst include an alkali metal compound, an alkaline earth metal compound, and a nitrogen-containing compound.

As the transesterification catalyst, for example, salts of zinc, tin, zirconium, lead or the like are preferably used alone or in combination. Specific examples include zinc acetate, zinc benzoate, zinc 2-ethylhexanoate, tin(II) chloride, tin(IV) chloride, tin(II) acetate, tin(IV) acetate, dibutyl tin dilaurate, dibutyl tin oxide, dibutyl tin dimethoxide, zirconium acetylacetonate, zirconium oxyacetate, zirconium tetrabutoxide, lead(II) acetate, and lead(IV) acetate.

Examples of the carbonate diester used in the secondary reaction include diphenyl carbonate, ditolyl carbonate, bis(chlorophenyl) carbonate, m-cresyl carbonate, dimethyl carbonate, diethyl carbonate, dibutyl carbonate, and dicyclohexyl carbonate. Among them, diphenyl carbonate is particularly favorable.

Unreacted monomers and carbonate diesters may remain in the biodegradable resin composition of one aspect of the present invention. The acceptable concentration of the residual monomer is 0 ppm-5,000 ppm, preferably 1 ppm-3,000 ppm. The acceptable concentration of the residual carbonate diester is 0 ppm-5,000 ppm, preferably 1 ppm-1,000 ppm.

The biodegradable resin composition of one aspect of the present invention may contain phenol that remains as a by-product of the polycondensation reaction. The acceptable concentration of the residual phenol is 1 ppm-5,000 ppm, preferably 10 ppm-3,000 ppm. For example, a cyclic dimer composed of succinic acid and 1,4-butanediol may remain. The acceptable concentration of the cyclic dimer is 1.0 mass % or less, preferably 0.6 mass % or less. A pelletized biodegradable resin composition may be immersed and extracted in a solvent that has low solubility for the biodegradable resin composition, such as water at a temperature of 20° C. to less than 100° C. or acetone, to reduce the concentration of the cyclic dimer in the biodegradable resin composition.

The biodegradable resin composition of one aspect of the present invention may be mixed with a resin other than polyester (PE) and polyester carbonate (PEC). Examples of such a resin include, but are not limited to, at least one resin selected from the group consisting of a polycarbonate resin, a (meth)acrylic resin, a poly amide resin, a polystyrene resin, a cyclo-olefin resin, an acrylonitrile-butadiene-styrene copolymer resin, a vinyl chloride resin, a polyphenylene ether resin, a polysulfone resin, a polyacetal resin, and a methyl methacrylate-styrene copolymer resin. These resins can be those of various known types, and one type of them can be used alone or two or more types of them can be used in combination.

The biodegradable resin composition of one aspect of the present invention preferably contains an antioxidant as an additive. While a commercially available product may be used as the antioxidant, for example, it preferably contains at least either one of an acid phenolic antioxidant and a phosphite-based antioxidant.

Examples of the phenolic antioxidant include 1,3,5-tris(3,5-di-tert-butyl-4-hydroxyphenylmethyl)-2,4,6-trimethylbenzene, 1,3,5-tris(3,5-di-tert-butyl-4-hydroxybenzyl)-1,3,5-triazine-2,4,6 (1H,3H,5H)-trione, 4,4′ 4″-(1-methylpropenyl-3-ylidene)tris(6-tert-butyl-m-cresol), 6,6′-di-tert-butyl-4,4′-butylidene di-m-cresol, octadecyl 3-(3,5-di-tert-butyl-4-hydroxyphenyl)propionate, pentaerythritol-tetrakis[3-(3,5-di-tert-butyl-4-hydroxyphenyl)propionate], 3,9-bis{2-[3-(3-tert-butyl-4-hydroxy-5-methylphenyl)propionyloxy]-1,1-dimethylethyl}-2,4,8,10-tetraoxospiro[5.5]undecane, and pentaerythritol-tetrakis[3-(3,5-di-tert-butyl-4-hydroxyphenyl)propionate], where pentaerythritol-tetrakis[3-(3,5-di-tert-butyl-4-hydroxyphenyl)propionate] is favorable.

Examples of the phosphite-based antioxidant include 2-ethylhexyl diphenyl phosphite, isodecyldiphenyl phosphite, triisodecyl phosphite, triphenyl phosphite, 3,9-bis(octadecyloxy)-2,4,8,10-tetraoxy-3,9 diphosphaspiro[5.5]undecane, 3,9-bis(2,6-di-tert-butyl-4-methylphenoxy)-2,4,8,10-tetraoxa-3,9-diphosphaspiro[5.5]undecane, 2,2′-methylenebis(4,6-di-tert-butylphenyl)2-ethylhexyl phosphite, tris(2,4-di-tert-butylphenyl)phosphite, tris(nonylphenyl)phosphite, tetra-C12-15-alkyl (propane-2,2-diylbis(4,1-phenylene))bis(phosphite), and 3,9-bis(2,6-di-tert-butyl-4-methylphenoxy)-2,4,8,10-tetraoxa-3,9-diphosphaspiro[5.5]undecane, where 3,9-bis(2,6-di-tert-butyl-4-methylphenoxy)-2,4,8,10-tetraoxa-3,9-diphosphaspiro[5.5]undecane is favorable.

As the antioxidant, one of the above-mentioned antioxidants may be used alone, or a mixture of two or more of them may be used.

In the biodegradable resin composition of one aspect of the present invention, the antioxidant is preferably contained in an amount of 1 ppm-3,000 ppm by weight relative to the total weight of the biodegradable resin composition. The content of the antioxidant is more preferably 50 ppm-2,500 ppm by weight, still more preferably 100 ppm-2,000 ppm by weight, particularly preferably 150 ppm-1,500 ppm by weight, and even more preferably 200 ppm-1,200 ppm by weight.

The biodegradable resin composition of one aspect of the present invention preferably contains a mold release agent as an additive.

Examples of the mold release agent include an ester compound, for example, a glycerol fatty acid ester such as a mono- or di-glyceride of a glycerol fatty acid, a glycol fatty acid ester such as a propylene glycol fatty acid ester and a sorbitan fatty acid ester, a higher alcohol fatty acid ester, and a full ester or mono-fatty acid ester of an aliphatic polyhydric alcohol and an aliphatic carboxylic acid.

When an ester of an aliphatic polyhydric alcohol and an aliphatic carboxylic acid is used as the mold release agent, it may be any of a monoester, full ester, or the like. For example, it may not be a full ester but a monoester or the like.

Specific examples of the mold release agent include the following:
a sorbitan fatty acid ester such as sorbitan stearate, sorbitan laurate, sorbitan oleate, sorbitan trioleate, sorbitan tribehenate, sorbitan stearate, sorbitan tristearate, and sorbitan caprylate;
a propylene glycol fatty acid ester such as propylene glycol monostearate, propylene glycol monooleate, propylene glycol monobehenate, propylene glycol monolaurate, and propylene glycol monopalmitate;
a higher alcohol fatty acid ester such as stearyl stearate;
a glycerol fatty acid ester monoglyceride, including: a monoglyceride such as glycerol monostearate, glycerol monohydroxystearate (e.g., glycerol mono-12-hydroxystearate), glycerol monooleate, glycerol monobehenate, glycerol monocaprylate, glycerol monocaprate, and glycerol monolaurate; and a mono- or di-glyceride such as glycerol mono- or di-stearate, glycerol mono- or di-stearate, glycerol mono- or di-behenate, and glycerol mono- or di-oleate;
an acetylated monoglyceride of a glycerol fatty acid ester such as glycerol diacetomonolaurate;
an organic acid monoglyceride of a glycerol fatty acid ester such as a citric acid ester of a monoglyceride of a fatty acid, a succinic acid ester of a monoglyceride of a fatty acid, and a diacetyl tartaric acid ester of a monoglyceride of a fatty acid; and
a polyglycerol fatty acid ester such as diglycerol stearate, diglycerol laurate, diglycerol oleate, diglycerol monostearate, diglycerol monolaurate, diglycerol monomyristate, diglycerol monooleate, tetraglycerol stearate, decaglycerol laurate, decaglycerol oleate, and polyglycerol polyricinoleate.

In the biodegradable resin composition of one aspect of the present invention, the mold release agent is preferably contained in an amount of 1 ppm-5,000 ppm by weight relative to the total weight of the biodegradable resin composition. The content of the mold release agent is more preferably 50 ppm-4,000 ppm by weight, still more preferably 100 ppm-3,500 ppm by weight, particularly preferably 500 ppm-13,000 ppm by weight, and even more preferably 1,000 ppm-2,500 ppm by weight.

In addition to the above-described antioxidant and mold release agent, other additives may be added to the biodegradable resin composition of one aspect of the present invention. Examples include a compounding agent, a catalyst inhibitor, a heat stabilizer, a plasticizer, a filler, a UV absorber, a corrosion inhibitor, a dispersant, an antifoaming agent, a leveling agent, a flame retardant, a lubricant, a dye, a pigment, a bluing agent, a nucleating agent, a clarifying agent (specifically, a sorbitol derivative, a hydroxy fatty acid-based amide, a triaminobenzene-based compound, anonitol-based compound, various celluloses, etc.), a starch (specifically, corn starch, waxy corn starch, high amylose corn starch, wheat starch, rice starch, potato starch, sweet potato starch, tapioca starch, pea starch, etc.), a lightfast agent (specifically, a hindered amine-based stabilizer such as bis(2,2,6,6-tetramethyl-1-(octyloxy)-4-piperidinyl) decanedioate, a reaction product of 1,1-dimethylethyl hydroperoxide with octane, bis(1,2,2,6,6-pentamethyl-4-piperidyl)[[3,5-bis(1,1-dimethylethyl)-4-hydroxyphenyl]methyl]butylmalonate, bis(1,2,2,6,6-pentamethyl-4-piperidyl)sebacate, methyl 1,2,2,6,6-pentamethyl-4-piperidyl sebacate, bis(2,2,6,6-tetramethyl-4-piperidyl)sebacate, 1-[2-[3-(3,5-di-tert-butyl-4-hydroxyphenyl)propionyloxy]ethyl]-4-[3-(3,5-di-tert-butyl-4-hydroxyphenyl)propionyloxy]-2,2,6,6-tetramethylpiperidine, poly[[6-(1,1,3,3-tetramethylbutyl)amino-1,3,5-triazine-2,4-diyl][(2,2,6,6-tetramethyl-4-piperidyl)imino]hexamethylene{(2,2,6,6-tetramethyl-4-piperidyl)imino}], etc.), an end-capping agent, an inorganic filler (specifically, a silicate such as anhydrous silica, mica, talcum, titanium oxide, calcium carbonate, siliceous earth, allophane, bentonite, potassium titanate, zeolite, sepiolite, smectite, kaolin, kaolinite, glass, limestone, carbon, wollastonite, calcined pearlite, calcium silicate, and sodium silicate; a hydroxide such as aluminum oxide, magnesium carbonate, and calcium hydroxide; and a salt such as ferric carbonate, zinc oxide, iron oxide, aluminum phosphate, and barium sulfate).

The content of additives other than the antioxidant and mold release agent in the biodegradable resin composition of one aspect of the present invention is, but not limited to, preferably 10 ppm to 5.0% by weight, more preferably 100 ppm to 2.0% by weight, and still more preferably 1,000 ppm to 1.0% by weight.

The additives mentioned above may adversely affect the transmissivity and should not be added in excess. For example, the total amount added is within the range mentioned above.

### [Application of Biodegradable Resin Composition]

Since the biodegradable resin composition of the present invention is easily decomposed by microorganisms in soil, compost, seawater, rivers, lakes, and swamps, it can be widely used, for example, when recycling is difficult. It also has excellent moldability and thus can be processed into various molded bodies, such as films, sheets, laminates, fibers, non-woven fabrics, yarns, and laminated bodies.

The following are examples of specific applications that could be implemented.

Specific examples include various bags such as shopping bags, packaging materials for magnetic tape cassette products such as video and audio tapes, flexible disk packaging materials, platemaking materials, packaging bands, adhesive tapes, tapes, yarns, cups, trays, cartons, lunch boxes, containers for prepared foods, food and confectionery packaging materials, food wrapping materials, inner coated materials for food and drink packages, shrink film for PET bottles, trays for fresh foods, containers and lunch boxes for fast foods, trash bags, cups, plates, chopsticks, spoons, forks, straws, wrapping materials for cosmetics and fragrances, plastic bags, diapers, sanitary napkins, wrapping materials for drugs, packaging materials for pharmaceuticals, packaging materials for surgical patches applied to stiff shoulders, sprains, etc., various packaging materials for foods, electronics, medical, chemicals, cosmetics, etc., parts of artificial hair and wig, artificial turf, body bags, and the like. Heat sealing is also possible if the product has a film shape.

Agricultural mulch films are used to cover soil surfaces to retain soil heat, prevent weed growth, prevent pest damage, and diffuse the sunlight by the fine unevenness made on the film surface, for the purposes of creating a suitable environment for growing vegetables and fruits, raising seedlings, and the like. Films that are spread outside the greenhouse are used for the purposes of preventing fog and haze, improving heat retention, preventing dust, and the like.

Examples of other agricultural materials include materials used in the agricultural, civil engineering, and fishery fields, such as multipurpose films, pots and strings for plants, coating materials for fertilizers, slow-release coating materials, horticultural films, wrapping films for agricultural chemicals, greenhouse films, fertilizer bags, pots for transplanting seedlings, seedling pots, waterproof sheets, sandbags, construction films, weed control sheets, vegetation nets made of tapes and yarns, water retaining films for wasteland and desert greening, sandbags, vegetation nets, fishing lines, fishing nets, seaweed nets, and pseudo bait. Other applications include trash bags and compost bags.

For medical and hygiene products, it can be used as medical materials for sutures, bandages, etc. and as hygiene materials for paper diapers, parts of sanitary products (polymer absorbent, waterproof film), etc.

It can also be used as disposable products such as leisure goods for golf, fishing, and marine sports, and as water treatment materials such as sedimentation agents, dispersants, and detergents.

### [Physical Properties of Biodegradable Resin Composition]

A biodegradable resin composition of one aspect of the present invention preferably has a weight average molecular weight (Mw) of 150,000 or more, more preferably 155,000 or more, and still more preferably 160,000 or more. In addition, the weight average molecular weight (Mw) is preferably 300,000 or less, more preferably 280,000 or less, and still more preferably 260,000 or less.

A biodegradable resin composition of another aspect of the present invention preferably has a weight average molecular weight (Mw) of 160,000 or more, more preferably 170,000 or more, and still more preferably 180,000 or more. In addition, the weight average molecular weight (Mw) is preferably 250,000 or less, more preferably 240,000 or less, and still more preferably 230,000 or less.

A biodegradable resin composition of still another aspect of the present invention preferably has a weight average molecular weight (Mw) of 150,000 or more, more preferably 155,000 or more, and still more preferably 160,000 or more. In addition, the weight average molecular weight (Mw) is preferably 200,000 or less, more preferably 190,000 or less, and still more preferably 180,000 or less.

A biodegradable resin composition of yet still another aspect of the present invention preferably has a weight average molecular weight (Mw) of 90,000 or more, more preferably 100,000 or more, and still more preferably 120,000 or more. In addition, the weight average molecular weight (Mw) is preferably 200,000 or less, more preferably 190,000 or less, and still more preferably 180,000 or less.

The biodegradable resin composition of one aspect of the present invention preferably has a melt volume-flow rate (MVR) of 5.50 cm³/10 min or more, more preferably 6.00 cm³/10 min or more, and still more preferably 6.50 cm³/10 min or more. While the upper limit of MVR is not particularly limited, it is preferably 20 cm³/10 min or less, more preferably 15 cm³/10 min or less, and still more preferably 10 cm³/10 min or less from the viewpoint of moldability.

The biodegradable resin composition of another aspect of the present invention preferably has a melt volume-flow rate (MVR) of 15.0 cm³/10 min or more, and more preferably 15.2 cm³/10 min or more. While the upper limit of MVR is not particularly limited, it is preferably 40 cm³/10 min or less, more preferably 30 cm³/10 min or less, and still more preferably 25 cm³/10 min or less from the viewpoint of moldability.

The biodegradable resin composition of still another aspect of the present invention preferably has a melt volume-flow rate (MVR) of 4.50 cm/10 min or more, more preferably 5.00 cm³/10 min or more, and still more preferably 7.50 cm³/10 min or higher. While the upper limit of MVR is not particularly limited and molding can be realized even when the MVR exceeds 100 cm³/10 min as described in EXAMPLES below, it may be, for example, 200 cm³/10 min or less or 150 cm³/10 min or less.

The method for measuring MVR is described in EXAMPLES below.

A molded body fabricated from the biodegradable resin composition of one aspect of the present invention preferably has a tensile elongation (%) of 170% or more, more preferably 172% or more, and still more preferably 174% or more. In addition, the tensile elongation (%) is preferably 200% or less, more preferably 195% or less, and still more preferably 192% or less.

A molded body fabricated from the biodegradable resin composition of another aspect of the present invention preferably has a tensile elongation (%) of 175% or more, more preferably 185% or more, and still more preferably 195% or more. In addition, the tensile elongation (%) is preferably 230% or less, more preferably 220% or less, and still more preferably 215% or less.

A molded body fabricated from the biodegradable resin composition of still another aspect of the present invention preferably has a tensile elongation (%) of 200% or more, and more preferably 250% or more. In addition, the tensile elongation (%) is preferably 500% or less, and more preferably 480% or less. However, as described in the examples below, the aforementioned molded bodies with a smaller tensile elongation are not necessarily inferior. For example, a molded body with a low tensile elongation but high flexural modulus may be highly useful. Therefore, the aforementioned molded body of one aspect may have a tensile elongation (%) of 5% or more, 10% or more, or 11% or more, and 50% or less, 30% or less, or 20% or less.

The method for measuring tensile elongation (%) is described in EXAMPLES below.

A molded body fabricated from the biodegradable resin composition of one aspect of the present invention preferably has a maximum tensile strength (MPa) of 33.5 MPa or more, more preferably 34.0 MPa or more, and still more preferably 34.2 MPa or more. In addition, the maximum tensile strength (MPa) is preferably 38.0 MPa or less, more preferably 37.5 MPa or less, and still more preferably 37.0 MPa or less.

A molded body fabricated from the biodegradable resin composition of another aspect of the present invention preferably has a maximum tensile strength (MPa) of 30.0 MPa or more, more preferably 31.5 MPa or more, and still more preferably 33.0 MPa or more. In addition, the maximum tensile strength (MPa) is preferably 45.0 MPa or less, more preferably 44.5 MPa or less, and still more preferably 43.0 MPa or less.

The method for measuring maximum tensile strength (MPa) is described in EXAMPLES below.

A molded body fabricated from the biodegradable resin composition of one aspect of the present invention preferably has a tensile yield strength (MPa) of 32.0 MPa or more, more preferably 32.5 MPa or more, and still more preferably 32.8 MPa or more. In addition, the tensile yield strength (MPa) is preferably 36.0 MPa or less, more preferably 35.5 MPa or less, and still more preferably 35.0 MPa or less.

A molded body fabricated from the biodegradable resin composition of another aspect of the present invention preferably has a tensile yield strength (MPa) of more than 28.0 MPa, more preferably 28.5 MPa or more, and still more preferably 30.0 MPa or more. In addition, the tensile yield strength (MPa) is preferably 35.0 MPa or less, more preferably 33.5 MPa or less, and still more preferably 32.0 MPa or less.

The method for measuring tensile yield strength (MPa) is described in EXAMPLES below.

A molded body fabricated from the biodegradable resin composition of one aspect of the present invention preferably has a flexural modulus (MPa) of 630 MPa or more, more preferably 632 MPa or more, and still more preferably 634 MPa or more. In addition, the flexural modulus (MPa) is preferably 670 MPa or less, more preferably 668 MPa or less, and still more preferably 664 MPa or less.

A molded body fabricated from the biodegradable resin composition of another aspect of the present invention preferably has a flexural modulus (MPa) of 590 MPa or more, more preferably 592 MPa or more, and still more preferably 594 MPa or more. In addition, the flexural modulus (MPa) is preferably 615 MPa or less, more preferably 613 MPa or less, and still more preferably 610 MPa or less.

A molded body fabricated from the biodegradable resin composition of still another aspect of the present invention preferably has a flexural modulus (MPa) of 430 MPa or more, more preferably 450 MPa or more, and still more preferably 465 MPa or more. In addition, the flexural modulus (MPa) is preferably 615 MPa or less, more preferably 613 MPa or less, and still more preferably 610 MPa or less. The method for measuring flexural modulus (MPa) is described in EXAMPLES below.

A molded body fabricated from the biodegradable resin composition of one aspect of the present invention preferably has a flexural stress (MPa) of 34.0 MPa or more, more preferably 34.4 MPa or more, and still more preferably 34.7 MPa or more. In addition, the flexural stress (MPa) is preferably 37.0 MPa or less, more preferably 36.8 MPa or less, and still more preferably 36.6 MPa or less.

A molded body fabricated from the biodegradable resin composition of another aspect of the present invention preferably has a flexural stress (MPa) of 33.7 MPa or more, more preferably 33.7 MPa or more, and still more preferably 34.0 MPa or more. In addition, the flexural stress (MPa) is preferably 35.5 MPa or less, more preferably 35.0 MPa or less, and still more preferably 34.8 MPa or less.

A molded body fabricated from the biodegradable resin composition of still another aspect of the present invention preferably has a flexural stress (MPa) of 26.0 MPa or more, more preferably 26.5 MPa or more, and still more preferably 28.0 MPa or more. In addition, the flexural stress (MPa) is preferably 35.5 MPa or less, more preferably 35.0 MPa or less, and still more preferably 34.8 MPa or less.

The method for measuring flexural stress (MPa) is described in EXAMPLES below.

A molded body fabricated from the biodegradable resin composition of one aspect of the present invention preferably has a notched Charpy impact strength (KJ/m²) of more than 8.8 KJ/m², more preferably 8.9 KJ/m² or more, and still more preferably 9.0 KJ/m² or more. In addition, the notched Charpy impact strength (KJ/m²) is preferably 12.0 KJ/m² or less, more preferably 11.5 KJ/m² or less, and still more preferably 11.0 KJ/m² or less.

A molded body fabricated from the biodegradable resin composition of another aspect of the present invention preferably has a notched Charpy impact strength (KJ/m²) of more than 8.3 KJ/m², more preferably 8.4 KJ/m² or more, and still more preferably 8.5 KJ/m² or more. In addition, the notched Charpy impact strength (KJ/m²) is preferably 10.0 KJ/m² or less, more preferably 9.5 KJ/m² or less, and still more preferably 9.0 KJ/m² or less.

A molded body fabricated from the biodegradable resin composition of still another aspect of the present invention preferably has a notched Charpy impact strength (KJ/m²) of 7.5 KJ/m or more, more preferably 8.0 KJ/m² or more, and still more preferably 10.0 KJ/m² or more. In addition, the notched Charpy impact strength (KJ/m²) is preferably 15.0 KJ/m² or less, more preferably 14.0 KJ/m² or less, and still more preferably 13.0 KJ/m² or less.

The method for measuring notched Charpy impact strength (KJ/m²) is described in EXAMPLES below.

### EXAMPLES

Hereinafter, the present invention will be described by way of examples, although the present invention should not be limited in any way to these examples. The values in the examples were measured using the following methods or instruments.

<Methods for measuring various physical properties and characteristics>

### (1) Hydroxyl Value (OH Value)

Hydroxyl value was measured in accordance with JIS K-1557.

### (2) Polystyrene-Equivalent Weight Average Molecular Weight (Mw) and Number Average Molecular Weight (Mn)

Instrument: High performance GPC HLC-8320 GPC, from Tosoh Corporation
Columns: SuperMultiporeHZ-M (4.6 mm I.D.×150 mm) GPC columns, from Tosoh Corporation (3 columns used in series)
Flow rate: 0.35 mL/min
Eluent: Chloroform
Sample Concentration: 0.2 w/v %
Detection unit: Blythe differential refractometer (RI Detector)

### (3) Tensile Characteristics (Tensile Elongation, Maximum Tensile Strength, and Tensile Yield Strength)

The resulting resin was molded into a dumbbell-shaped test piece (type A12 test piece) in accordance with JIS K 7139: 2009 to measure tensile elongation, maximum tensile strength, and tensile yield strength in accordance with JIS K 7161-2: 2014. The detailed conditions of the test pieces and the measurement methods are described below.

Test pieces:
Molding equipment: C, Mobile-0813, from EPSON TcFORM Corporation
Molding temperatures: Manifold 150° C., body 170° C., tip 70%
   Setting temperature of mold: 40° C.
Extrusion screw speed: 90 rpm
Measurement rate: 2 mm/s
Injection rate: 20 mm/s

Measurement methods:
Measurement instrument: Autograph AGS-X, from Shimadzu Corporation
Maximum load cell capacity: 500N
Test rate: 0.5 mm/min, 25 mm/min after elastic deformation
Distance between jigs: 50 mm
Tensile elongation: Determined from the stroke travel distance of the test instrument relative to the initial distance between the jigs.
Maximum tensile strength: Determined from the maximum strength obtained between the start of the test to the fracture of the test piece.
Tensile yield strength: Determined from the first point at which the test force decreased by 0.1% relative to the full-scale output of the load cell.
Number (N) of test cycles: 3

### (4) Bending Characteristics (Flexural Modulus and Flexural Stress)

Similar test pieces as those used in (3) Tensile characteristics (tensile elongation, maximum tensile strength, and tensile yield strength) above were used to measure the flexural modulus and flexural stress by a three-point flexural test in accordance with JIS K 7171: 2016. The detailed conditions of the measurement methods are described below.
Measurement instrument: Autograph AGS-X, from Shimadzu Corporation
Maximum load cell capacity: 500N
Distance between fulcrums: 32 mm
Standard sample thickness: 2 mm
Test rate for flexural modulus: 1 mm/min
Test rate for flexural stress: 5 mm/min
Number (N) of test cycles: 3

### (5) Notched Charpy Impact Strength

Notched Charpy impact strength was measured in accordance with JIS K 7111-1: 2012/1eA. The detailed conditions of the test pieces and the measurement method are described below.

Test pieces:
Molding equipment: C, Mobile-0813, from EPSON TcFORM Corporation
Molding temperatures: Manifold 150° C., body 170° C., tip 70%
   Setting temperature of mold: 40° C.
Extrusion screw speed: 90 rpm
Measurement rate: 2 mm/s
Injection rate: 20 mm/s
Shape of test piece: Strip-like test piece 10 mm×80 mm×2 mm
Notching tool: Notching tool model A-4E, from Toyo Seiki Seisaku-sho, Ltd.
Strike direction: Edge-wise
Notch Shape: A
Notch tip radius: 0.25
Remaining width after notching: Standard 8.0 mm

Measurement:
Measurement instrument: DG-CB, from Toyo Seiki Seisaku-sho, Ltd.
Number (N) of test cycles: 3

### Polymerization Example 1 for Polyester (PE; Prepolymer) (PE1)

As raw materials, 75.445 kg (639 mol) of succinic acid, 80.605 kg (894 mol) of 1,4-butanediol, 557 g (4.2 mol) of trimethylolpropane, and 2.750 g (5.6E-03 mol, 25 ppm relative to the theoretical amount of resin produced) of zirconium(IV) acetylacetonate as a catalyst were placed in a 400 L reaction vessel equipped with a condenser and a stirring blade.

After replacing the inside of the reaction vessel with nitrogen, the internal temperature of the reaction vessel was heat-controlled at normal pressure (101.33 kPa) to reach 215° C. and the water produced by the dehydration-condensation reaction of succinic acid and 1,4-butanediol was removed by condensation in a condenser.

Once 90% of the water was removed relative to the theoretical total amount of water produced, the internal temperature of the reaction vessel was heat-controlled to reach 200-205° C., and the pressure in the reaction vessel was reduced in steps to 0.25 kPa. The reaction was continued under the reaction vessel conditions of an internal temperature of 200-205° C. and 0.25 kPa to obtain a polyester (prepolymer). The physical properties of the resulting polyester (PEt) are shown in Table 1.

### Polymerization Example 2 for Polyester (PE; Prepolymer) (PE2)

A polyester (PE2) was obtained in the same manner as in Polymerization example 1 for polyester (PE; prepolymer) described above, except that trimethylolpropane was not used as a raw material. The physical properties of the resulting polyester (PE2) are shown in Table 1.

### Polymerization Example 1 for Polyester Carbonate (PEC) (PEC1)

77.025 kg of the polyester (PEL1) obtained in Polymerization example 1 for polyester (PE; prepolymer) described above, 11.023 kg (51 mol) of diphenyl carbonate (DPC), and 5.860 g (2.7E-02 mol, 75 ppm relative to the prepolymer) of zinc acetate dihydrate as a catalyst were placed in a 300 L reaction vessel equipped with a condenser and a stirring blade.

After replacing the inside of the reaction vessel with nitrogen, the internal temperature of the reaction vessel was heat-controlled at normal pressure (101.33 kPa) to reach 220° C. and the phenol produced by transesterification was removed by condensation in a condenser. Subsequently, the pressure inside the reaction vessel was reduced in steps to 0.25 kPa to obtain a polyester carbonate (PEC1). The physical properties of the resulting polyester carbonate (PEC1) are shown in Table 2.

### Polymerization Example 2 for Polyester Carbonate (PEC) (PEC2)

A polyester carbonate (PEC2) was obtained in the same manner as in Polymerization example 1, except that 71.730 kg of the polyester (PE1) obtained in Polymerization example 1 for polyester (PE; prepolymer) described above, 8.725 kg (41 mol) of diphenyl carbonate (DPC), and 2.910 g (1.3E-02 mol, 40 ppm relative to the prepolymer) of zinc acetate dihydrate as a catalyst were used. The physical properties of the resulting polyester carbonate (PEC2) are shown in Table 2.

### Polymerization Example 3 for Polyester Carbonate (PEC) (PEC3)

A polyester carbonate (PEC3) was obtained in the same manner as in Polymerization example 1 for polyester carbonate, except that 77.025 kg of the polyester (PE2) obtained in Polymerization example 2 for polyester (PE; prepolymer) described above, 10.734 kg (50 mol) of diphenyl carbonate (DPC), and 5.860 g (2.7E-02 mol, 75 ppm relative to the prepolymer) of zinc acetate dihydrate as a catalyst were used as raw materials. The physical properties of the resulting polyester carbonate (PEC3) are shown in Table 2.

TABLE 1

| Physical properties of PE | | PE1 | PE2 |
|---|---|---|---|
| Weight average molecular | Mw | 5,184 | 5,011 |
| weight | | | |
| Number average molecular | Mn | 2,820 | 2,105 |
| weight | | | |
| Mw/Mn | — | 1.839 | 2.380 |
| Hydroxyl value | Mass % | 2.25 | 2.19 |
| | mgKOH/g | 74.3 | 72.3 |

TABLE 2

| Physical | | | | |
|---|---|---|---|---|
| properties of | | | | |
| PEC | | PEC1 | PEC2 | PEC3 |
| Weight average | Mw | 197,690 | 176,788 | 224,923 |
| molecular | | | | |
| weight | | | | |
| Number | Mn | 56,723 | 51,645 | 108,847 |
| average | | | | |
| molecular | | | | |
| weight | | | | |
| Mw/Mn | — | 3.49 | 3.42 | 2.07 |

### Example 1

The above PEC1 as a polyester carbonate and the above PE2 as a prepolymer were melt-kneaded at proportions of 99 mass % and 1 mass %, respectively. Kneading conditions are shown below. The physical properties of the resulting biodegradable resin composition are shown in Table 3.
Extruder: Small twin-screw segment extruder 2D15W, from Toyo Seiki Seisaku-sho, Ltd.
L/D: 17
Temperature settings: C1/C2/Die=130° C./150° C./150° C.
Feeder speed: 10 rpm
Discharge rate: set at 400 g/h

### Examples 2-6 and Comparative Examples 1-2

Melt-kneading was performed in the same manner as in Example 1, except that polyester carbonates and polyesters (prepolymers) shown in Tables 3 and 4 were used. The physical properties of the resulting biodegradable resin compositions are shown in Tables 3 and 4.

### Examples 7-10 and Comparative Example 3

Melt-kneading was performed in the same manner as in Example 1, except that the polyester carbonate and the polyester (prepolymer) shown in Table 5 were used. The physical properties of the resulting biodegradable resin compositions are shown in Table 5. In Table 5, “-” indicates that no clear yield point was observed (in this case, the maximum tensile strength may be regarded as the tensile yield strength).

TABLE 3

| | | Comparative | | | |
|---|---|---|---|---|---|
| | | example 1 | Example 1 | Example 2 | Example 3 |
| Composition | Type of PEC | PEC1 | PEC1 | PEC1 | PEC1 |
| of | PEC (mass %) | 100 | 99 | 97 | 95 |
| biodegradable | Type of PE | PE2 | PE2 | PE2 | PE2 |
| resin | PE (mass %) | 0 | 1 | 3 | 5 |
| composition | Total | 100 | 100 | 100 | 100 |
| | (mass %) | | | | |
| Physical | Mw | 197,190 | 203,133 | 191,097 | 186,434 |
| properties of | Mn | 62,270 | 64,004 | 52,127 | 49,855 |
| biodegradable | Mw/Mn | 3.17 | 3.17 | 3.67 | 3.74 |
| resin | MVR | 5.33 | 6.88 | 7.71 | 9.07 |
| composition | (cm³/10 min) | | | | |
| | Tensile | 175 | 174 | 188 | 192 |
| | elongation (%) | | | | |
| | Maximum | 36.5 | 36.5 | 35.3 | 34.4 |
| | tensile strength | | | | |
| | (MPa) | | | | |
| | Tensile yield | 33.5 | 32.9 | 33.1 | 34.3 |
| | strength (MPa) | | | | |
| | Flexural | 640 | 636 | 660 | 658 |
| | modulus | | | | |
| | (MPa) | | | | |
| | Flexural stress | 34.6 | 34.7 | 35.4 | 36.0 |
| | (MPa) | | | | |
| | Notched | 8.8 | 10.4 | 10.3 | 9.1 |
| | Charpy impact | | | | |
| | test (kJ/m²) | | | | |

TABLE 4

| | | Comparative | | | |
|---|---|---|---|---|---|
| | | example 2 | Example 4 | Example 5 | Example 6 |
| Composition | Type of PEC | PEC2 | PEC2 | PEC2 | PEC2 |
| of | PEC (mass %) | 100 | 99 | 97 | 95 |
| biodegradable | Type of PE | PE2 | PE2 | PE2 | PE2 |
| resin | PE (mass %) | 0 | 1 | 3 | 5 |
| composition | Total | 100 | 100 | 100 | 100 |
| | (mass %) | | | | |
| Physical | Mw | 166,753 | 169,220 | 168,365 | 160,113 |
| properties of | Mn | 48,927 | 49,618 | 50,472 | 41,859 |
| biodegradable | Mw/Mn | 3.41 | 3.41 | 3.34 | 3.83 |
| resin | MVR | 14.8 | 15.3 | 17.1 | 21.6 |
| composition | (cm³/10 min) | | | | |
| | Tensile | 194 | 195 | 205 | 213 |
| | elongation (%) | | | | |
| | Maximum | 35.5 | 34.8 | 35.5 | 35.1 |
| | tensile strength | | | | |
| | (MPa) | | | | |
| | Tensile yield | 32.7 | 33.1 | 33.2 | 33.5 |
| | strength (MPa) | | | | |
| | Flexural | 591 | 594 | 593 | 608 |
| | modulus | | | | |
| | (MPa) | | | | |
| | Flexural stress | 33.5 | 34.5 | 34.0 | 34.4 |
| | (MPa) | | | | |
| | Notched | 8.3 | 8.5 | 8.5 | 8.9 |
| | Charpy impact | | | | |
| | test (kJ/m²) | | | | |

TABLE 5

| | | Comparative | | | | |
|---|---|---|---|---|---|---|
| | | example 3 | Example 7 | Example 8 | Example 9 | Example 10 |
| Composition | Type of PEC | PEC3 100 | PEC3 90 | PEC3 80 | PEC3 70 | PEC3 50 |
| of | PEC | | | | | |
| biodegradable | (mass %) | | | | | |
| resin | Type of PE | PE1 0 | PE1 10 | PE1 20 | PE1 30 | PE1 50 |
| composition | PE (mass %) | | | | | |
| | Total | 100 | 100 | 100 | 100 | 100 |
| | (mass %) | | | | | |
| Physical | Mw | 201,599 | 171,056 | 156,911 | 131,221 | 95,585 |
| properties of | Mn | 95,556 | 11,669 | 10,995 | 8,207 | 4,382 |
| biodegradable | Mw/Mn | 2.11 | 14.66 | 14.27 | 15.99 | 21.82 |
| resin | MVR | 4.4 | 9.5 | 23.0 | 41.9 | >100 |
| composition | (cm³/10 | | | | | |
| | min) | | | | | |
| | Tensile | 424 | 47.5 | 272 | 18.0 | 11.3 |
| | elongation | | | | | |
| | (%) | | | | | |
| | Maximum | 42.7 | 44.4 | 33.7 | 33.8 | 33.2 |
| | tensile | | | | | |
| | strength | | | | | |
| | (MPa) | | | | | |
| | Tensile yield | 28.0 | 30.3 | 31.8 | — | — |
| | strength | | | | | |
| | (MPa) | | | | | |
| | Flexural | 421 | 465 | 497 | 540 | 605 |
| | modulus | | | | | |
| | (MPa) | | | | | |
| | Flexural | 25.6 | 28.0 | 29.9 | 31.7 | 34.8 |
| | stress (MPa) | | | | | |
| | Notched | Did not | Did not | 12.8 | 11.6 | 8.0 |
| | Charpy | fracture | fracture | | | |
| | impact test | | | | | |
| | (kJ/m²) | | | | | |

Examples 1-3 and Comparative example 1 shown in Table 3 represent physical properties of a series of biodegradable resin compositions with large Mw. Examples 4-6 and Comparative example 2 shown in Table 4 represent physical properties of a series of biodegradable resin compositions with small Mw. Examples 7-10 and Comparative example 3 shown in Table 5 represent a series that use PEC3 obtained without trimethylolpropane (branching agent).

As shown in Tables 3-5, in every series, the biodegradable resin compositions of Examples 1-3, Examples 4-6, and Examples 7-10, each comprising a poly ester containing a structural unit (A) derived from a monomer represented by general formula (1) and a structural unit (B) derived from a monomer represented by general formula (2) and a poly ester carbonate containing a structural unit (A) derived from a monomer represented by general formula (1) and a structural unit (B) derived from a monomer represented by general formula (2), are found to have superior melt flowability compared to those of Comparative examples 1, 2, and 3, respectively.

The values of various physical properties of the molded bodies fabricated from the biodegradable resin compositions of Examples 1-3, Examples 4-6, and Examples 7-10 show that they have better overall mechanical strength than the molded bodies of Comparative examples 1, 2, and 3, respectively. As shown in Table 5, Examples 9 and 10 (which contained 30 mass % or more prepolymer) had extremely low tensile elongation and lost ductility, but had improved flexural modulus and excellent flexural strength.

As described above, the biodegradable resin compositions of the present invention had excellent melt flowability while maintaining good mechanical strength.

1: A biodegradable resin composition, comprising:
a polyester containing a structural unit (A) derived from a monomer represented by formula (1) and a structural unit (B) derived from a monomer represented by formula (2); and
a polyester carbonate containing a structural unit (A) derived from a monomer represented by the formula (1) and a structural unit (B) derived from a monomer represented by the formula (2): 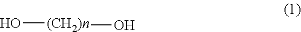
where n represents an integer of 4-16, 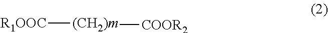
where R₁ and R₂ are each independently selected from the group consisting of a hydrogen atom and a C1-C5 alkyl group, and m represents an integer of 2-16.

2: The resin composition according to claim 1, wherein a mass ratio of the polyester to the polyester carbonate is from 0.1:99.9 to 50:50.

3: The resin composition according to claim 1, wherein the polyester has a hydroxyl value of 30-140 mgKOH/g.

4: The resin composition according to claim 1, wherein the polyester has a weight average molecular weight of 3,000-8,000.

5: The resin composition according to claim 1, wherein the polyester carbonate has a weight average molecular weight of 100,000-300,000.

6: The resin composition according to claim 1, wherein
the monomer represented by the formula (1) comprises 1,4-butanediol, and
the monomer represented by the formula (2) comprises succinic acid or adipic acid.

7: The resin composition according to claim 1, wherein at least one of the monomer represented by genera the formula (1) and the monomer represented by the formula (2) is derived from a biomass resource.

8: A molded body, comprising: the biodegradable resin composition according to claim 1.
